(19) United States
(12) Patent Application Publication
(10) Pub. No.: US 2025/0364855 A1
(43) Pub. Date: Nov. 27, 2025

(54) SEGMENTED ROTOR FOR A SLOTLESS, ELECTRONICALLY COMMUTATED ELECTRIC MOTOR, AND ELECTRIC MOTOR COMPRISING SUCH A ROTOR

(71) Applicant: Maxon International AG, Sachseln (CH)

(72) Inventors: Johannes KREHER, Lungern (CH); Bjorn WICKI, Luzern (CH)

(21) Appl. No.: 19/129,577

(22) PCT Filed: Nov. 17, 2023
(86) PCT No.: PCT/EP2023/082193

§ 371 Date: May 13, 2025

(30) Foreign Application Priority Data
Nov. 18, 2022 (EP) 22208209.1

(51) Int. Cl. H02K 1/2753; H02K 1/02

(52) U.S. Cl. CPC H02K 1/2753; H02K 1/02

(57) ABSTRACT

The rotor has a slotless stator, an electronic commutator, and permanent magnet segments. The permanent magnet segments are mutually spaced at least over an axial region of the rotor along at least one sectional plane, and the rotor has a respective electric insulation between the permanent magnet segments along the at least one sectional plane. A normal of the respective sectional plane runs perpendicularly to the axial direction of the rotor and perpendicularly to the q-axis of the rotor if the rotor has one pole pair and perpendicularly to one of a plurality of q-axes of the rotor if the rotor has more than one pole pair. A soft magnetic material is introduced between the permanent magnet segments along the sectional plane(s). The material is electrically insulated by means of the electric insulation of the permanent magnet segments.

### CROSS-REFERENCE TO RELATED APPLICATION

This application claims priority to and the benefit of PCT Patent App. PCT/EP2023/082193, filed on Nov. 17, 2023, and entitled “SEGMENTED ROTOR FOR A SLOTLESS ELECTRONICALLY COMMUTATED ELECTRIC MOTOR, AND ELECTRIC MOTOR COMPRISING SUCH A ROTOR,” and to European Patent App. No. EP 22208209.1, filed on Nov. 18, 2022, and entitled “SEGMENTED ROTOR FOR A SLOTLESS ELECTRONICALLY COMMUTATED ELECTRIC MOTOR, AND ELECTRIC MOTOR COMPRISING SUCH A ROTOR,” the entire contents of both being herein incorporated by reference.

### BACKGROUND

### 1. Field

The present disclosure relates to a rotor for an electric motor comprising a slotless stator and an electronic commutator.

### 2. Related Art

Some types of rotors have permanent magnet segments.

In electronically commutated electric motors, additional losses are induced in the electric motor by the pulse width modulation (PWM) of the power electronics. These losses are particularly high in low-inductance motors such as electrically commutated electric motors with slotless stators. The main effect here is eddy currents in the rotor, in the case of a fixed intermediate circuit voltage the additional losses being at maximum at a duty cycle of 50%. There are already known solutions to this known problem, but they come with additional problems.

A well-known approach is the use of additional inductors in the electronics, which can reduce current ripple and thus the losses. Depending on the system, however, these additional inductors become large, heavy and expensive. In addition, ohmic losses occur in these components, making this approach less advantageous.

It is also known to select the winding voltage and/or intermediate circuit voltage so that the duty cycle is almost 100%. This avoids the problem of PWM-induced losses. However, without adjustment of the intermediate circuit voltage, this is only possible for motors that are mainly operated at maximum speed. If operation is to take place at different speeds, a complex and expensive control system is required for adjusting the intermediate circuit voltage, which also affects the dynamics of the control system. In addition, this approach only partially solves the problem in the case of sinusoidal commutations, since the voltage has a sinusoidal curve and thus the duty cycle is continuously changed from zero to the maximum.

Another well-known approach is axial segmentation of the rotor into permanent magnet segments, the rotor being segmented along sectional planes whose normals point in the axial direction of the rotor, and the individual permanent magnet segments being electrically insulated from each other.

However, for effective suppression of eddy currents, a large number of such permanent magnet segments are required here, since the axial thickness of the permanent magnet segment disks should be less than their diameter. This makes this approach complex to manufacture and expensive.

### SUMMARY

The object of the present disclosure is therefore to provide a rotor for an electric motor comprising a slotless stator and an electronic commutator, which reduces the additional losses induced by the pulse width modulation (PWM) of the power electronics and thereby avoids or at least mitigates the problems of the various known approaches described above.

In a rotor of the type in question, the object is achieved according to the present disclosure in that the permanent magnet segments are mutually spaced at least over an axial region of the rotor along at least one sectional plane, and the rotor has a respective electric insulation between the permanent magnet segments along the at least one sectional plane. A normal of the respective sectional plane runs perpendicularly to the axial direction of the rotor and perpendicularly to a q-axis of the rotor if the rotor has one pole pair and perpendicularly to one of a plurality of q-axes of the rotor if the rotor has more than one pole pair.

In this case, an extension of the sectional planes in the axial direction is limited to the axial region of the rotor, the axial region of the rotor preferably comprising at least 90%, particularly preferably at least 95%, of the axial length of the rotor.

By means of the solution according to the present disclosure, the eddy currents in the rotor induced by the PWM can be effectively prevented. This requires a significantly smaller number of permanent magnet segments than the known approach with sectional planes with normals in the axial direction of the rotor.

This makes the rotor much easier and more cost-effective to manufacture.

Advantageous embodiments of the present disclosure are the subject-matter of the dependent claims.

In a particularly preferred embodiment of the present disclosure, the electrical insulation is created by means of an air gap, an insulating material, such as preferably a potting compound, plastic films or platelets, paper or a coating, such as preferably an electrically insulating adhesive. Effective electrical insulation effectively prevents the induced eddy currents of the PWM. An electric motor can be designed as a multi-phase or single-phase electric motor and can rotate or oscillate during operation.

In a further preferred embodiment of the present disclosure, a soft magnetic material is introduced between the permanent magnet segments along the sectional plane(s), this material being electrically insulated from the permanent magnet segments by means of the electrical insulation. This increases the inductance in the direction of the q-axis/axes, which can reduce the current ripple and thus additionally also reduce the induced eddy currents. Electrical insulation can already be achieved with a relatively low electrical resistance in the order of a few ohms, for example 1-10 ohms, since this already reduces the eddy currents.

Preferably, the soft magnetic material is designed as a lamination or laminated core, a lamination direction running either parallel to the normal of the respective sectional plane or in the axial direction of the rotor. This makes possible the formation of a high-magnitude inductance in a simple and cost-effective manner.

In a preferred embodiment, a saturation field strength of the soft magnetic material lies above the flux density of the rotor, the soft magnetic material preferably consisting of FeSi laminations, FeNi laminations or a soft magnetic composite. This makes it possible to prevent saturation of the soft magnetic material, which ensures effectiveness in preventing losses due to PWM-induced eddy currents.

According to a further particularly preferred embodiment, a spacing between the permanent segments in the direction of the normals of the respective sectional plane over at least 50% of the extent of the sectional plane parallel to the q-axis within an outer circumference of the rotor is less than 8%, preferably less than 5%, of the rotor diameter. This allows the permanent segments to be made sufficiently large in relation to the rotor diameter.

In a further preferred embodiment, the laminated core has a lamination direction parallel to the normals of the respective sectional plane and fewer than nine, preferably fewer than five, laminations. The direction in which the laminations are placed or stacked on top of each other is called the lamination direction. The lamination direction is therefore perpendicular or orthogonal to the lamination plane.

In another preferred embodiment, the laminated core has the lamination direction in the axial direction of the rotor and an extension of the laminated core in the direction of the normals of the respective sectional plane increases at the outer circumference of the rotor. This allows more high-frequency field to be directed into the laminated core, which has a positive effect on reducing losses due to PWM-induced eddy currents. In addition, the laminations are positioned in the rotor by the positive connection with the permanent magnet segments.

According to a further preferred embodiment, the rotor has only one pole pair and more than two, preferably three, permanent magnet segments, the sectional planes preferably being arranged axially symmetrically to the q-axis of the rotor. For rotors with only one pole pair, the use of more than two permanent magnet segments can further reduce losses due to PWM-induced eddy currents. In this case, three permanent magnet segments are usually sufficient.

According to another preferred embodiment, the rotor has more than one pole pair and the sectional planes of the rotor run along the q-axes of the rotor. If the rotors have more than one pole pair, more than one q-axis will be formed. By the sectional planes running along each of these q-axes, PWM-reduced eddy currents can be effectively prevented over the entire rotor circumference.

In a further particularly preferred embodiment of the present disclosure, the permanent magnet segments are glued to one another in an electrically insulated manner. Segmentation makes the rotor structure more fragile. However, by gluing, a sufficiently robust rotor can be produced.

According to a preferred embodiment of the present disclosure, shaft stubs are glued to the end faces of the rotor. In particular in embodiments of the rotor having only one pole pair, a continuous shaft is less practical, since in this case eddy currents could flow across the shaft. In order to prevent this, shaft stubs are used.

In a further preferred embodiment of the present disclosure, the rotor is surrounded by an electrically non-conductive encapsulation, which is preferably a carbon fiber tube or a ceramic sleeve or consists of a synthetic resin lamination of the outer surface. This can further improve robustness. The carbon fiber tube has the additional advantage that carbon fiber has a similar expansion coefficient to magnetic material. This makes the rotor robust in relation to temperature changes. The carbon fiber tube can also be impregnated with epoxy resin and cured or baked. This increases the strength of the rotor, and in addition the coating serves as insulation.

In another preferred embodiment, the axial region in which the permanent magnet segments are spaced apart from one another constitutes only a partial region of the total axial length of the rotor, and the permanent magnet segments are designed to be unsegmented at an axial end of the rotor in an end portion which preferably comprises less than 10%, particularly preferably less than 5%, of the axial length of the rotor. This can reduce the fragility of the rotor while still reducing PWM-induced eddy currents. The embodiment with such an end portion is particularly preferred for rotors with only one pole pair.

In another preferred embodiment, the rotor is designed as a four-pole Halbach rotor comprising eight permanent magnet segments, the permanent magnet segments being electrically insulated from one another at the sectional planes along the q-axes and these sectional planes being provided with soft magnetic laminations which are also electrically insulated from the permanent magnet segments.

The present disclosure further relates to an electric motor having a slotless stator and an electronic commutator, the electric motor comprising a rotor according to at least one of the embodiments described above.

### BRIEF DESCRIPTION OF THE DRAWINGS

In the following, non-limiting embodiments of the present disclosure are explained in more detail with reference to drawings shown by way of example,

in which:

FIG. 1: is a sectional view of an embodiment of a rotor according to the disclosure comprising a pole pair, a sectional plane and a laminated core having a lamination direction parallel to the normals of the sectional plane,

FIG. 2: is a sectional view of a second embodiment of a rotor according to the disclosure comprising a pole pair, a sectional plane and a laminated core having a lamination direction in the axial direction of the rotor,

FIG. 3: is a sectional view of a third embodiment of a rotor according to the disclosure comprising a pole pair, two sectional planes and two laminated cores having a lamination direction parallel to the normals of the sectional planes,

FIG. 4: shows axial sectional views of the third embodiment shown in FIG. 3,

FIG. 5: is a sectional view of a fourth embodiment of a rotor according to the disclosure comprising two pole pairs, two sectional planes and four laminated cores having lamination directions parallel to the normals of the sectional plane,

FIG. 6: is a sectional view of a fifth embodiment of a rotor according to the disclosure comprising two pole pairs, two sectional planes and a laminated core having a lamination direction in the axial direction of the rotor,

FIG. 7: is a schematic sectional view of a fifth embodiment of a rotor according to the disclosure, which is designed as a four-pole Halbach rotor.

### DETAILED DESCRIPTION OF THE ENABLING EMBODIMENT

In the following illustrations, identical parts are provided with the same reference signs. If a figure contains reference signs that are not explicitly discussed in the corresponding figure description, reference is made to preceding or subsequent figure descriptions. The figures show only sectional views of embodiments of rotors according to the present disclosure. The other components of the electric motor, which is also claimed, are not shown in the figures. For the components of the electric motor according to the present disclosure, reference is made to the general description.

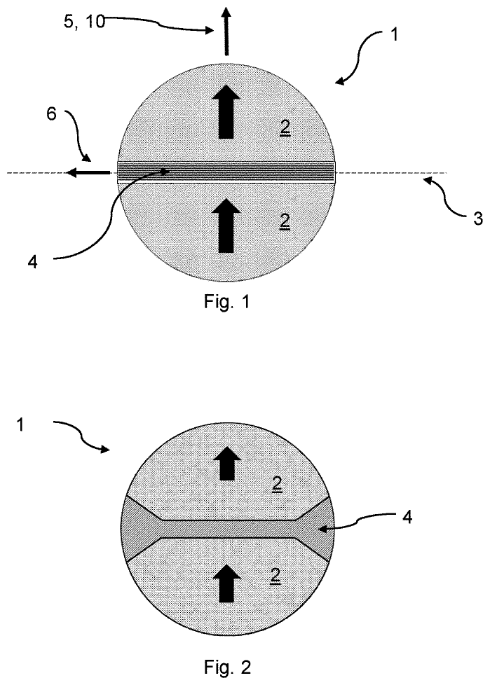

FIG. 1 is a sectional view of a first embodiment of a rotor 1 according to the present disclosure within an axial region 8 of the rotor 1, in which said rotor is divided into a plurality of permanent magnet segments 2. In this case, the rotor 1 has two permanent magnet segments 2 in the axial region 8, the magnetization directions of which are shown as thick black arrows and which form a single-pole-pair magnetic field. The magnetization direction is also indicated by the d-axis 5 of the rotor 1. The two permanent magnet segments 2 are spaced apart from one another along a sectional plane 3. In this case, the sectional plane 3 has a normal 10 which is aligned perpendicularly to the axial direction of the rotor 1 and perpendicularly to the q-axis 6 of the rotor 1. Between the two permanent magnet segments 2, soft magnetic material in the form of a laminated core 4 is introduced along the sectional plane 3, the laminated core 4 of this embodiment having a lamination direction parallel to the normals 10 of the sectional plane 3 and having eight laminations. Alternatively, fewer laminations, for example less than five laminations, can preferably also be used. The two permanent magnet segments 2 and the laminated core 4 are electrically insulated from each other by electrical insulation. The electrical insulation between the permanent magnet segments 2 along the sectional plane 3 prevents PWM-induced eddy currents, which are particularly strong in electronically commutated electric motors with slotless stators, and have a negative effect on the operation of such an electric motor. The laminated core 4 also increases the inductance in the q-axis 6, which reduces the current ripple and as a result the eddy currents can be additionally reduced. The electric motor can be a multi-phase electric motor.

FIG. 2 is a sectional view in the axial region 8 of a second embodiment of a rotor 1 according to the disclosure. The essential difference from the first exemplary embodiment is that the laminated core has a lamination direction in the axial direction of the rotor 1 and the extension of the laminated core 4 increases in the direction of the normals 10 on the sectional plane 3 toward the outer circumferences of the rotor 1. This allows, on the one hand, more high-frequency field to be conducted into the axial laminated core 4 and, on the other hand, the laminations of the laminated core 4 are positioned in relation to the permanent magnet segments 2 by means of a positive fit. For this exemplary embodiment too, it is important that the laminated core 4 is electrically insulated from the permanent magnet segments 2 by electrical insulation.

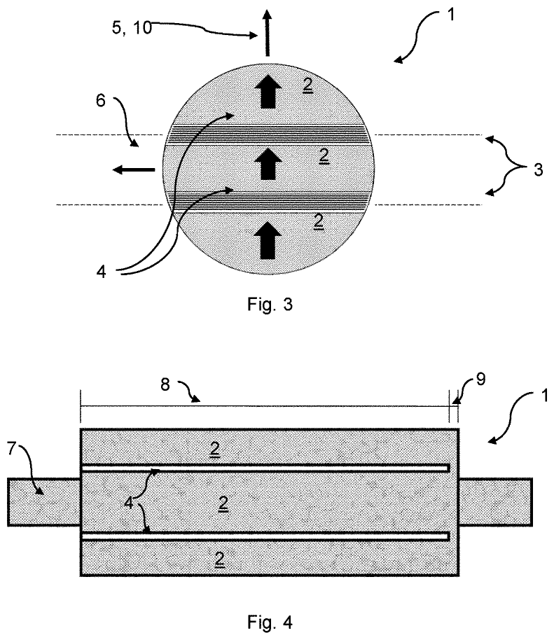

FIG. 3 is a sectional view in the axial region 8 of a third exemplary embodiment of a rotor 1 according to the disclosure, this rotor 1 having three permanent magnet segments 2, which all have the same magnetization direction and thus form a single-pole-pair magnetic field. The permanent magnet segments 2 are spaced apart from one another along two sectional planes 3, each having normals 10 oriented perpendicularly to the axial direction of the rotor 1 and perpendicularly to the q-axis 6 of the rotor 1. In this case, the sectional planes 3 are arranged axially symmetrically to the q-axis 6 in the rotor. Laminated cores 4 are again inserted between the permanent magnet segments 2 along the sectional planes 3, the laminated cores 4 being electrically insulated from the respectively adjacent permanent magnet segments 2 by electrical insulation.

FIG. 4 is an axial sectional view of a rotor 1, with a sectional view in the axial region 8, like the third exemplary embodiment shown in FIG. 3. The rotor 1 is segmented in the axial region 8 and has 3 permanent magnet segments 2 which are divided by two sectional planes. However, this segmentation is not present over the entire axial length of rotor 1. The embodiment in FIG. 4 thus has an end portion 9 at one axial end, in which the permanent magnet segments 2 are not separated from one another. In the end portion 9, the permanent magnet can be formed in one piece, so that the robustness of the rotor 1 can be increased. Since the axial region 8 with the segmentation into a plurality of permanent magnet segments 2 includes a large part of the axial length, preferably at least 90% of the axial length, the PWM-induced eddy currents can still be sufficiently reduced. Shaft stubs are glued to the respective axial ends of the rotor 1 shown in FIG. 4, which, together with the segmented permanent magnet, form the shaft 7 of the rotor 1.

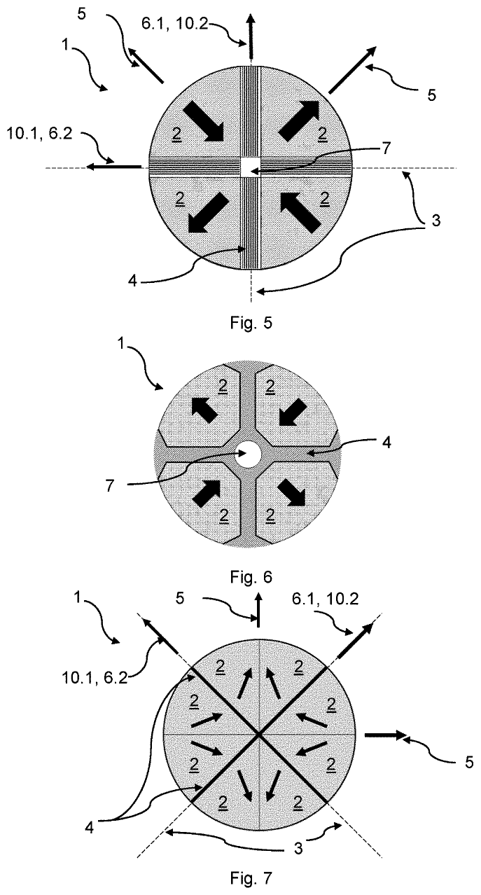

FIG. 5 is a sectional view of a further embodiment of a rotor 1 according to the disclosure, this rotor 1 being a two-pole-pair rotor. The rotor 1 has four permanent magnet segments 2, which are magnetized according to the thick black arrows. The permanent magnet segments 2 are spaced apart from one another along two sectional planes 3, the normals 10.1 of the sectional planes 3 each being aligned perpendicularly to the axial direction of the rotor 1 and perpendicularly to the possible q-axes 6.1, 6.2 of the rotor 1. The laminations are arranged in the direction of the q-axis 6, 6.1, 6.2, which means that the q-axis 6, 6.1, 6.2 lies in the lamination plane. The d-axes 5 are each electrically perpendicular to the q-axis 6, 6.1, 6.2. In the case of a single-pole-pair motor, the d-axes 5 are in each case both electrically and mechanically or geometrically perpendicular to the q-axis 6, and thus parallel to the normals 10. In the case of multi-pole-pair rotors, there are a plurality of d-axes 5 and q-axes 6.1, 6.2 corresponding to the number of pole pairs. In this case, the d-axes 5 and q-axes 6.1, 6.2 are each electrically perpendicular to each other at a 90° angle. In contrast, the mechanical angle between the d-axes 5 and the q-axes 6.1, 6.2 corresponds to half of 360° divided by the number of poles. In the case of a rotor 1 with two pole pairs, a mechanical angle between the d-axis 5 and the q-axis 6.1, 6.2 of 360°/2/4=45° thus results. In the case of a three-pole-pair rotor 1, a mechanical angle between the d-axis and the q-axis of 360°/2/6=30° results. Soft magnetic material in the form of laminated cores 4, which have a lamination direction parallel to the normals of the sectional planes, is introduced along the sectional planes 3. The laminated cores 4 and the permanent magnet segments 2 are insulated from each other by electrical insulation. No shaft of the rotor 1 is provided between the laminated cores 4 in the center of the rotor 1. In an alternative embodiment, a shaft made of an electrically non-conductive material may be arranged.

FIG. 6 is also a sectional view of a further exemplary embodiment of a rotor 1 according to the disclosure, which is designed as a two-pole-pair rotor 1. In contrast to the exemplary embodiment shown in FIG. 5, this embodiment has a laminated core 4 with a lamination direction in the axial direction of the rotor 1, which is inserted along the sectional planes 3 between the permanent magnet segments 2. The extension of the laminated core 4 in the direction of the normals 10 of the sectional planes 3 increases at the outer circumference of the rotor, as a result of which on the one hand more high-frequency field can be directed into the axial laminated core 4 and the laminations of the laminated core 4 are positioned relative to each other and to the permanent magnet segments 2. In the exemplary embodiment shown in FIG. 6, a shaft 7 of the rotor 1 is guided through the axial laminated core 4. In this embodiment, the shaft 7 has a diameter which is greater than the minimum distance between the permanent magnet segments 2 along the sectional planes 3. In this case, the field is guided around the shaft 7.

FIG. 7 is a sectional view through a further exemplary embodiment of a rotor 1 according to the disclosure, the rotor 1 being a two-pole-pair Halbach rotor 1 which is formed from eight permanent magnet segments 2 with magnetization directions marked as black arrows. These permanent magnet segments 2 are also spaced apart from one another along two sectional planes 3 by means of electrical insulation, the normals 10.1, 10.2 of the sectional planes 3 each being aligned perpendicularly to the axial direction of the rotor 1 and to a respective q-axis 6.1, 6.2 of the rotor 1. Soft magnetic material in the form of laminated cores 4 can also be introduced along these sectional planes 3, the laminated cores 4 in turn being insulated from the permanent magnet segments 2 by electrical insulation.

For the exemplary embodiments described above, in each case the electrical insulation can be produced inter alia by means of an air gap, an insulating material, plastic films or platelets, paper, or a coating such as an electrically insulated adhesive. The rotors shown can also be covered with a carbon fiber tube and laminated with synthetic resin or covered with a ceramic sleeve so that the robustness of the rotor 1 can be increased. In this case, it is important that this type of encapsulation is not electrically conductive, as this would negate the effect of segmentation.

What is claimed is:

1. A rotor for an electric motor, comprising:
a slotless stator and an electronic commutator,
wherein the rotor has permanent magnet segments,
wherein the permanent magnet segments are mutually spaced at least over an axial region of the rotor along at least one sectional plane,
wherein the rotor has a respective electric insulation between the permanent magnet segments along the at least one sectional plane, wherein a normal of the respective sectional plane runs perpendicularly to the axial direction of the rotor and perpendicularly to a q-axis of the rotor if the rotor has one pole pair, and perpendicularly to one of a plurality of q-axes of the rotor if the rotor has more than one pole pair, and
wherein a soft magnetic material is introduced between the permanent magnet segments along the sectional plane(s), said material being electrically insulated by means of the electric insulation of the permanent magnet segments.

2. The rotor according to claim 1, wherein the electrical insulation is created by means of an air gap, an insulating material, plastic films, platelets, paper or a coating.

3. The rotor according to claim, wherein the soft magnetic material is designed as a lamination or laminated core, a lamination direction running either parallel to the normal of the respective sectional plane or in the axial direction of the rotor.

4. The rotor according to claim 1, wherein a saturation field strength of the soft magnetic material lies above the flux density of the rotor.

5. The rotor according to one of claim 1, wherein a spacing between the permanent segments in the direction of the normal of the respective section plane over at least 50% of the extent of the section plane parallel to the q-axis within an outer circumference of the rotor is less than 8% of the rotor diameter.

6. The rotor according to one of claim 1, wherein the laminated core has the lamination direction parallel to the normal of the respective sectional plane and less than nine laminations.

7. The rotor according to claim 1, wherein the laminated core has the lamination direction in the axial direction of the rotor and an extension of the laminated core increases in the direction of the normal of the respective section plane on the outer circumference of the rotor.

8. The rotor according to claim 1, wherein the rotor has only one pole pair and more than two permanent magnet segments.

9. The rotor according to claim 1, wherein the rotor has more than one pole pair and the sectional planes of the rotor run along the q-axes of the rotor.

10. The rotor according to claim 1, wherein the permanent magnet segments are glued to each other in an electrically insulated manner.

11. The rotor according to claim 1, wherein shaft stubs are glued to the end faces of the rotor.

12. The rotor according to claim 1, wherein the rotor is surrounded by an electrically non-conductive encapsulation.

13. The rotor according to claim 1, wherein the axial region, in which the permanent magnet segments are spaced apart from one another, only constitutes a partial region of the total axial length of the rotor, and wherein the permanent magnet segments at an axial end of the rotor are designed to be unsegmented in an end portion, which is less than 10% of the axial length of the rotor.

14. An electric motor comprising a slotless stator and an electronic commutator, wherein the electric motor has a rotor according to claim 1.

15. The rotor according to claim 4, wherein the soft magnetic material includes FeSi laminations, FeNi laminations or a soft magnetic composite.

16. The rotor according to claim 5, wherein the spacing between the permanent segments in the direction of the normal of the respective section plane over at least 50% of the extent of the section plane parallel to the q-axis within the outer circumference of the rotor is less than 5% of the rotor diameter.

17. The rotor according to claim 5, wherein the less than nine laminations is further defined as less than five laminations.

18. The rotor according to claim 8, wherein the rotor has three permanent magnet segments and wherein the sectional plane is arranges symmetrically to the q-axis of the rotor.

19. The rotor according to claim 12, wherein the non-conductive encapsulation is a carbon fiber tube or a ceramic sleeve or includes a synthetic resin lamination.

20. The rotor according to claim 13, wherein the end portion is less than 5% of the axial length of the rotor.
